(19) United States
(12) Patent Application Publication
(10) Pub. No.: US 2008/0312918 A1
(43) Pub. Date: Dec. 18, 2008

(54) VOICE PERFORMANCE EVALUATION SYSTEM AND METHOD FOR LONG-DISTANCE VOICE RECOGNITION

(75) Inventor: Hyun-Soo Kim, Yongin-si (KR)

Correspondence Address: THE FARRELL LAW FIRM, P.C., 333 EARLE OVINGTON BOULEVARD, SUITE 701, UNIONDALE, NY, 11553, US

(73) Assignee: SAMSUNG ELECTRONICS CO., LTD., Suwon-si (KR)

(21) Appl. No.: 12/141,306

(22) Filed: Jun. 18, 2008

(30) Foreign Application Priority Data
Jun. 18, 2007 (KR) 59489/2007

(51) Int. Cl. G10L 15/20

(52) U.S. Cl. 704/233

(57) ABSTRACT

A system and a method are provided for evaluating a voice performance in order to recognize a long-distance voice. The system implements a voice performance evaluation function for long-distance voice input in a robot. Particularly, in robots including a network robot, it is required to normally perform voice recognition so that a speaking subject and a surrounding situation can be recognized by a robot. Accordingly, in order to obtain the most optimal voice quality, it is important to find a noise removal algorithm through an optimal hardware configuration and an optimal combination of the optimal hardware configuration and software. Therefore, a method for finding a noise removal algorithm appropriate for each of cases, including one case where a distance from a speaking subject is fixed and another case where a distance from a speaking subject changes. As a result, the most optimal voice quality can be obtained regardless of a noise environment even when the speaking subject is a long distance away from the robot.

### PRIORITY

This application claims priority under 35 U.S.C. §119(a) to an application entitled “Voice Performance Evaluation System and Method for Long-Distance Voice Recognition” filed in the Korean Intellectual Property Office on Jun. 18, 2007 and assigned Serial No. 2007-59489, the contents of which are incorporated herein by reference.

### BACKGROUND OF THE INVENTION

1. Field of the Invention

The present invention relates to a system and a method for voice recognition in a robot, and more particularly, to a system and a method for evaluating a voice performance in order to recognize a long-distance voice by a robot.

2. Description of the Related Art

In a mobile robot, a voice input system is not only essential to interaction between a user and the mobile robot, but also becomes an important issue for autonomous driving. In an indoor environment, important problems caused in a voice input system of the mobile robot are noise, echoes, and distance. There exist various noise sources in an indoor environment, such as walls or other objects which may cause echoes. Depending on distance, a low frequency component of a voice has a more attenuated characteristic than a high frequency component thereof. Therefore, in an indoor environment of a home, a voice input system necessary for interaction between a user and a robot must be able to be directly used for voice recognition by receiving the user's normal voice when the autonomous navigation mobile robot is several meters away from the user.

The robot recognizes the user's voice input through a microphone. When considering the user's convenience, it would be useful for a voice recognition function in the robot to function even at a long distances. As compared with a case where the distance between a microphone and a user is short, there is a basic need for significantly increasing the gain of a pre-amplifier for long-distance voice recognition. However, in this case, noise is amplified as well as a voice, and therefore, removing the noise is helpful for improved performance in voice recognition and to improve the clarity of a voice in voice communication. Accordingly, criteria for selecting or developing an effective algorithm for long-distance voice recognition are necessary.

In order to succeed in voice recognition using the microphone at a location where a speaking subject is a long distance away from the robot, it is necessary to improve voice quality by removing various kinds of noises affecting the speaking subject's utterance, e.g. background noise, echo waveforms in an indoor environment, channel distortion caused by the microphone and a line or a channel, etc. The removal of the various kinds of noises is referred to as a preprocessing stage for the voice recognition.

To this end, there exists a method for evaluating a voice performance through setting of parameters, such as a gain, according to a particular noise removal algorithm in a fixed hardware configuration, such as a selected relevant microphone, an array configuration of selected microphones, and the like. However, the most optimal voice quality is hard to obtain by means of the fixed hardware configuration and the particular noise removal algorithm, as described above in a system which continues to change and has various noise environments.

In such a mobile system as the robot, the distance of the mobile system from the speaking subject may change. In such an actual environment, it is required to find and use an optimal microphone array configuration and optimal combination/setting between the optimal microphone array configuration and a noise removal algorithm appropriate for a situation.

The existing voice performance evaluation method uses a single hardware configuration and a particular noise removal algorithm, and accordingly, has a limit on applying it to the mobile system, such as the robot. Also, there exists no method for finding an optimal combination of a hardware configuration and software for a long distance voice input in such a manner as to ensure an optimal voice input.

### SUMMARY OF THE INVENTION

The present invention has been made to address at least the above problems and/or disadvantages and to provide at least the advantages described below. Accordingly, an aspect of the present invention provides a system and a method for evaluating a voice performance in order to recognize a long-distance voice by a robot.

Another aspect of the present invention provides a system and a method for evaluating a voice performance, which enables finding a noise removal algorithm through an optimal hardware configuration and an optimal combination of the optimal hardware configuration and software in such a manner as to ensure the most optimal voice quality in a noise environment.

According to one aspect of the present invention, a system is provided for evaluating a voice performance in order to recognize a long-distance voice. The system includes a voice source direction search unit for finding a voice source direction in which a speaking subject is located so that multiple microphones face the voice source direction. The system also includes a distance measurement unit for measuring a distance from the speaking subject, and a voice input unit comprising the multiple microphones, for selecting a microphone necessary for a microphone array configuration in response to the measured distance. The system further includes a noise removal unit for applying a noise removal algorithm to be tested to a voice input through the voice input unit and removing noise from the input voice, and a performance evaluation verification unit for applying a performance evaluation criterion in order to numerically express a performance of the voice provided by the noise removal unit. Additionally, the system includes a noise removal algorithm selection unit for determining if the noise removal algorithm is selected based on a result of comparing a numerical value calculated by the performance evaluation verification unit with a reference value.

According to another aspect of the present invention, a system is provided for evaluating a voice performance in order to recognize a long-distance voice. The system includes a voice source direction search unit for finding a voice source direction so that multiple microphones face the voice source direction; a voice database for storing therein voices recorded in the same collection environment necessary to evaluate a noise removal algorithm to be tested. The system also includes a voice input unit comprising the multiple microphones for receiving as input a voice provided by the voice database, for selecting a microphone necessary for a microphone array configuration, and a noise removal unit for applying the noise removal algorithm to be tested to a voice input through the voice input unit and removing noise from the voice; a performance evaluation verification unit for applying a performance evaluation criterion in order to numerically express a performance of the voice provided by the noise removal unit. The system further includes a noise removal algorithm selection unit for determining if the noise removal algorithm is selected based on a result of comparing a numerical value calculated by the performance evaluation verification unit with a reference value.

According to a further aspect of the present invention, a method is provided for evaluating a voice performance in order to recognize a long-distance voice. A voice source direction is found in which a speaking subject is located so that multiple microphones face the voice source direction. A distance from the speaking subject is measured, and a microphone necessary for a microphone array configuration is selected in response to the measured distance. A noise removal algorithm to be tested is applied to a voice input through the microphone and noise from the input voice is removed. A performance evaluation criterion is applied for numerically expressing a performance of the voice whose noise has been removed. A numerical value calculated is compared according to a result of applying the performance evaluation criterion with a reference value. It is determined if the noise removal algorithm is selected based on a result of comparing the numerical value with the reference value.

According to an additional aspect of the present invention, a method is provided for evaluating a voice performance in order to recognize a long-distance voice. Voices recorded in the same collection environment necessary to evaluate a noise removal algorithm to be tested are stored. A voice source direction is found so that multiple microphones face the voice source direction. A microphone is selected for receiving as input a reproduced voice at a predetermined distance during the reproduction of the stored voice. The noise removal algorithm to be tested is applied to the reproduced voice and noise is removed from the reproduced voice. A performance evaluation criterion is applied for numerically expressing a performance of the reproduced voice whose noise has been removed. It is determined if the noise removal algorithm is selected based on a result of comparing a numerical value calculated by a result of applying the performance evaluation criterion with a reference value.

### BRIEF DESCRIPTION OF THE DRAWINGS

The above and other features, aspects, and advantages of the present invention will be more apparent from the following detailed description when taken in conjunction with the accompanying drawings, in which:

FIG. 1 is a diagram illustrating a voice collection environment used to evaluate a noise removal algorithm according to an embodiment of the present invention;

FIG. 2 is a block diagram illustrating the configuration of a voice evaluation system according to an embodiment of the present invention;

FIG. 3 is a flowchart illustrating a control process for selecting a noise removal algorithm when a distance from a speaking subject is fixed according to an embodiment of the present invention; and

FIGS. 4A and 4B are a flowchart illustrating a control process for selecting a noise removal algorithm when a distance from a speaking subject changes according to an embodiment of the present invention.

### DETAILED DESCRIPTION OF THE PREFERRED EMBODIMENTS

Preferred embodiments of the present invention are described in detail with reference to the accompanying drawings. It should be noted that similar components are designated by similar reference numerals although they are illustrated in different drawings. Detailed descriptions of constructions or processes known in the art may be omitted to avoid obscuring the subject matter of the present invention.

The present invention implements a voice performance evaluation function for long-distance voice input in a robot. Particularly, in robots including a network robot, it is required to normally perform voice recognition so that a speaking subject and a surrounding situation can be recognized by a robot. Accordingly, in order to obtain the most optimal voice quality, it is very important to find a noise removal algorithm through an optimal hardware configuration and an optimal combination of the optimal hardware configuration and software. Therefore, the embodiments of the present invention provide a method for finding a noise removal algorithm appropriate for each of cases, including one case where a distance from a speaking subject is fixed and another case where a distance from a speaking subject changes. By doing this, the most optimal voice quality can be obtained regardless of a noise environment even when the speaking subject is a long distance away from the robot.

In the following description, a robot according to the embodiments of the present invention includes a network robot. The network robot can provide various services anytime and anywhere through the communication of a robot platform with a server by using a wire/wireless associated protocol and network security technology through a network (e.g. a wire network and a wireless network).

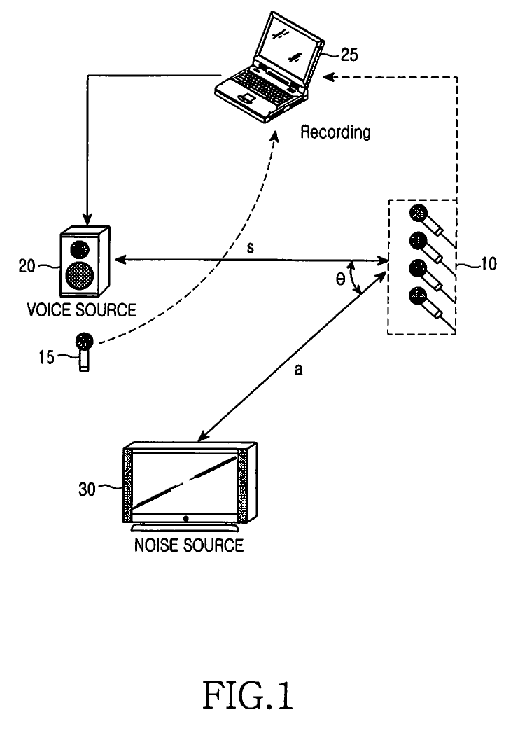

Meanwhile, a method for evaluating a voice performance in the embodiments of the present invention refers to a method for evaluating a multi-channel noise removal algorithm, and an input voice needs to be any one of voices collected in the same environment in order to evaluate the multi-channel noise removal algorithm. This type of voice collection environment can be set as illustrated in FIG. 1. The voice collection environment can be set with multiple equal microphones and a noise source, and accordingly, is not limited to the setting as illustrated in FIG. 1.

FIG. 1 illustrates an example of the voice collection environment used to evaluate a noise removal algorithm according to an embodiment of the present invention, where a microphone array is very important. In the voice collection environment, voices are recorded differently depending on the number of microphones, an interval between the microphones, a distance from a reference microphone, a sampling rate, a type of noise, a strength of a voice or noise, the degree of an angle, and a type of the microphones.

First, a microphone array 10 including multiple multi-channel microphones, a reference microphone 15, a measurement device 25, which has noise removal algorithms therewithin and records therein a voice provided through a speaker (i.e. an electric speaker) 20, functioning as a point source and the microphones, and a noise source 30, such as music and sound from a television set, can be arranged in a space of a predetermined size as illustrated in FIG. 1. In FIG. 1, it is assumed that the reference microphone 15 receives as input a voice from the speaker 20 at a predetermined distance from the speaker 20. Also, the microphone array 10 is located at a location which is “s” away from the speaker 20, and at a location which is “a” away from the noise source 30, where an angle between the speaker 20 and the noise source 30 is equal to θ.

Meanwhile, a gain should first be determined in reproducing a voice signal through the speaker 20. Before reproducing the voice signal through the speaker 20, a pure sinusoidal signal with a frequency of 1 kHz is generated, and the magnitude of the generated pure sinusoidal signal is determined to be 80 dB when it is measured by a noise meter at a location of 1 meter from the speaker 20. The magnitude as described above is equal to the level of noise generated when operating a vacuum cleaner at a location of 1 meter from a measurement point.

Also, a gain of a microphone preamplifier (or a mic preamp gain) needs to be adjusted, wherein an evaluation measure proposed in the present invention is not a value which changes depending on each mic preamp gain. Nevertheless, when collecting voices, a mic preamp gain of the microphone array 10 should be adjusted to be the same as that of the reference microphone 15. At this time, when adjusting the gain of the speaker 20 and then receiving as input a voice signal through the reference microphone 15, the occurrence of clipping is not allowed.

In the voice collection environment as described above, by inputting collected voice signals to microphones when the collection of the voice signals is completed, a noise removal algorithm for actual voice recognition by a robot can be found.

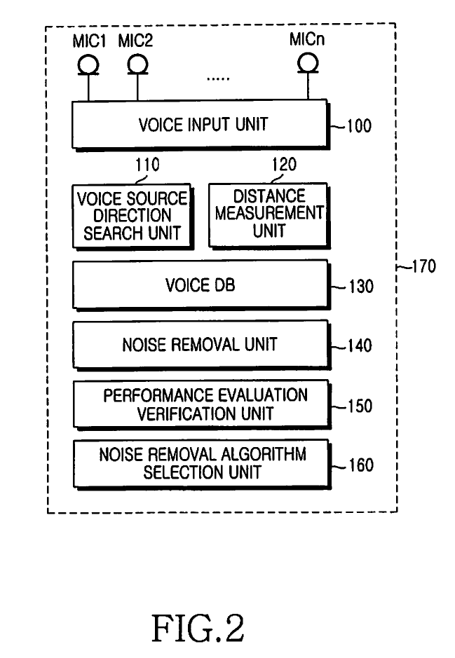

Hereinafter, a description of the present invention continues with reference to FIG. 2, which is a block diagram illustrating the configuration of a voice evaluation system (i.e. a voice performance evaluation system) according to an embodiment of the present invention for finding a noise removal algorithm necessary to evaluate a voice performance.

Referring to FIG. 2, the voice evaluation system 170 includes a voice input unit 100, a voice source direction search unit 110, a distance measurement unit 120, a voice database (DB) 130, a noise removal unit 140, a performance evaluation verification unit 150, and a noise removal algorithm selection unit 160.

First, the voice input unit 100 includes multiple microphones, MIC1, MIC2 . . . MICn, and functions as selecting a microphone necessary for a microphone array configuration in response to a distance of the voice input unit 100 from a speaking subject. The voice input unit 100 selects a relevant microphone for each type and sensitivity of the microphones in response to the distance of the voice input unit 100 from the speaking subject. The voice input unit 100 has a built-in microphone array driving unit which moves microphones as selected above, and adjusts each interval between the microphones. Herein, the microphone array driving unit arranges the multiple microphones, for each of which a sensitivity, a type, and a size are considered, so as to face the voice source direction, and then moves each microphone in order to adjust each interval between the microphones. Depending on the interval between the moved microphones, parameters and a gain of the noise removal algorithm are tuned and used.

The voice source direction search unit 110 finds the voice source direction in which the speaking subject is located so that the multiple microphones of the voice input unit 100 may face the voice source direction. In a system having a fixed distance thereof from a speaking subject, the speaking subject as described above may be a speaker from which a voice stored in the voice database 130 is output. At this time, when a noise removal algorithm intended to be used is an algorithm of a beam-forming series, setting of the microphone array driving unit after tracking a voice source changes according to a fixed beam-forming method an adaptive beam-forming method.

Specifically, when a fixed beam-forming scheme has a broadside form, the voice source direction search unit moves a relevant microphone using the microphone array driving unit in order to configure the microphone array in a state parallel to the voice source direction. Also, when a fixed beam-forming scheme has an endfire form, the voice source direction search unit moves a relevant microphone by using the microphone array driving unit in order to configure the microphone array in a state perpendicular to the voice source direction. On the other hand, the voice source direction search unit 110 forms a virtual beam in order to face the voice source direction in the case of an adaptive beam-forming scheme.

The distance measurement unit 120 functions as measuring a distance from the speaking subject when the distance from the speaking subject changes, as in the case of a mobile robot. At this time, the distance from the speaking subject is measured by using a sensing device, such as an ultrasonic sensor, a laser sensor, and a stereo camera, and auxiliary information may be acquired by using three-dimensional technology for tracking a voice source.

The voice database 130 stores therein normal voice data recorded for each of various speaking subjects, and stores therein voice data recorded in the same collection environment necessary to evaluate a noise removal algorithm to be tested in order to find an optimal noise removal algorithm in response to the distance from the speaking subject.

The noise removal unit 140 applies the noise removal algorithm to be tested to a voice input through the voice input unit 100 and removes noise from the voice. At this time, the voice input through the voice input unit 100 may be one of voices previously stored in the voice database 130.

The performance evaluation verification unit 150 numerically expresses a performance of the voice provided by the noise removal unit 140. By doing this, the performance evaluation verification unit 150 can evaluate the performance of the voice provided by the noise removal unit 140. Specifically, the performance evaluation verification unit 150 functions as numerically expressing a recognition rate, an error reduction rate, a voice attenuation degree, a voice distortion degree, etc., of the input voice so that it can objectively measure voice quality. For the numerical expression as described above, the present invention provides six performance evaluation criteria.

The noise removal algorithm selection unit 160 determines if a numerical value regarding the performance of the voice provided by the performance evaluation verification unit 150 satisfies a predetermined range of criteria. If it is determined that a numerical value calculated when applying a selected noise removal algorithm to the voice input through the voice input unit 100 is in the predetermined range of criteria, the noise removal algorithm selection unit 160 determines that the selected noise removal algorithm is an optimal noise removal algorithm in a current environment, and definitely determines the selection of the noise removal algorithm. On the contrary, if it is determined that a numerical value calculated when applying the selected noise removal algorithm to the voice input through the voice input unit 100 is outside the predetermined range of criteria, the noise removal algorithm selection unit 160 determines that the selected noise removal algorithm is unsuitable, and accordingly, determines that the noise removal algorithm is unacceptable. As described above, the noise removal algorithm selection unit 160 verifies the noise removal algorithm to be tested.

Meanwhile, in the performance evaluation verification unit 150 according to one embodiment of the present invention, performance evaluation criteria for numerically expressing the performance of the voice to which the noise removal algorithm is applied, are defined by the equations set forth below.

$$error reduction rate \% = ( voice recognition rate after removing noise - voice recognition rate before removing noise ) / ( 100 - voice recognition rate before removing noise ) \times 100 \qquad ( 1 )$$

Equation (1) is a formula for calculating an error reduction rate, and the larger the error reduction rate, the higher a voice recognition rate. Specifically, when a voice recognition function is mounted in a robot, not only the voice recognition rate but also the error reduction rate are very important factors. When the speaking subject speaks a voice command intended to be a goal, the voice recognition rate represents a success rate at which a voice recognition system correctly recognizes the relevant voice. Accordingly, it is noted that better performance is obtained as the value of a voice recognition rate becomes larger. Meanwhile, regardless of whether the same voice recognition rates are calculated, the best performance is obtained when the value of an error reduction rate is the largest.

$$S N {R}_{avg} = 10 {log}_{10} ( \frac{{\sum }_{t ∈ {T}_{s}} {s}^{2} ( t ) - {\sum }_{t ∈ {T}_{n}} {s}^{2} ( t )}{{\sum }_{t ∈ {T}_{n}} {s}^{2} ( t )} ) \qquad ( 2 A )$$

Equation (2A) is a formula for calculating an average Signal-to-Noise Ratio (SNR) in all voice signals. In Equation (2A), Tₛ represents a voice period, Tₙ represents a noise period, and s(t) represents a signal.

SNR increase rate %=(SNR after removing noise−SNR before removing noise)/SNR before removing noise×100 (2B)

Equation (2B) is a formula for calculating an SNR increase rate representing an energy ratio of a voice to noise. It can be noted that the better performance is obtained as the value of an SNR increase rate defined by Equation (2B) becomes larger. In order to calculate the SNR increase rate, the voice period and a non-voice period need to be known. Regardless of whether the same SNRs are calculated, the best performance is obtained when the value of an SNR increase rate is largest.

$$I S = \frac{1}{M} {\sum }_{m = 0}^{M - 1} [ \frac{{σ}_{m , clean}^{2}}{{σ}_{m , proc}^{2}} \cdot \frac{{\overline{a}}_{m , clean} {R}_{m , clean} {\overline{a}}_{m , clean}^{T}}{{\overline{a}}_{m , proc} {R}_{m , clean} {\overline{a}}_{m , proc}^{T}} + log ( \frac{{σ}_{m , proc}^{2}}{{σ}_{m , clean}^{2}} ) - 1 ] \qquad ( 3 )$$

Equation (3) is a formula for calculating an Itakura-Saito distortion measure. In Equation (3), M represents the number of frames, m represents a frame index, α̅_{m,clean} represents a Linear Predictive Coding (LPC) vector of an m-th frame of a non-corrupt and clean voice, α̅_{m,proc} represents an LPC vector of an m-th frame of a processed voice, σ²_{m,clean} represents an all-pole gain of the non-corrupt and clean voice, σ²_{m,proc} represents an all-pole gain of the processed voice, and R_{m,clean} represents a Toeplitz autocorrelation matrix of the m-th frame of the non-corrupt and clean voice.

The Itakura-Saito distortion measure represents a degree of similarity between an LPC spectrum of the non-corrupt and clean voice signal and an LPC spectrum of the noise removal-processed voice signal, and is measured during the voice period. As the measurement value of the Itakura-Saito distortion measure becomes smaller, a better performance is obtained.

$${C}_{dist} = \frac{1}{M} {\sum }_{m = 0}^{M - 1} [ {\vert \frac{1}{P} {\sum }_{p = 0}^{p - 1} [ {c}_{m , clean} ( p ) - {c}_{m , proc} ( p ) ] \vert}^{2} ] \qquad ( 4 )$$

Equation (4) is a formula for calculating a Cepstral distance. In Equation (4), M represents the number of frames, m represents a frame index, c_{m,clean}(t) represents a Cepstral coefficient of an m-th frame of a non-corrupt and clean voice, c_{m,proc}(t) represents a Cepstral coefficient of an m-th frame of a processed voice, and P represents an order of a Cepstral coefficient.

Through a difference between Cepstral coefficients of a Mel-spectrum based on an auditory model, the Cepstral distance as defined in Equation (4) represents a pure voice distortion degree regardless of an attenuation degree. The value of a Cepstral distance as defined in Equation (4) is measured during the voice period, and a better performance is obtained as the value of the Cepstral distance becomes smaller.

Besides Equations (1) to (4) as defined above, perceptual performance evaluation of a voice, i.e. Perceptual Evaluation of Speech Quality (PESQ), may be used. The PESQ is a measure used to indicate how similar a voice signal input through each of other comparative microphones and a noise removal-processed voice signal are to a voice signal input through a reference microphone in terms of a clarity degree. In order to indicate the similarity degree by using the PESQ, they have been compared with the voice signal input through the reference microphone. The value of a PESQ is a numerical value used to measure a degree of an objective voice quality improvement which is matched with a similar value to subjective telephone-call quality (i.e. a Mean Option Score (MOS)) used when evaluating voice quality. The value of the PESQ ranges from −0.5 to 4.5, and the more approximate value to 4.5 is calculated for the PESQ as a distortion degree of a voice signal becomes smaller as compared with the reference voice. Namely, as the value of the PESQ gets closer to 4.5, the better performance is obtained.

$$Seg - S N R = \frac{10}{M} {\sum }_{m = 0}^{M - 1} log [ \frac{{\sum }_{n = Nm}^{N ( m + 1 ) - 1} {S}^{2} ( n )}{{\sum }_{n = Nm}^{N ( m + 1 ) - 1} {( S ( n ) - \hat{S} ( n ) )}^{2}} ] \qquad ( 5 )$$

Equation (5) is a formula for calculating a segmental SNR (i.e. an SNR for each segment) of a voice signal. In Equation (5), S(n) represents an original voice signal, Ŝ(n) represents a re-synthesized voice signal, and M and N represent a frame number and the length of a current frame, respectively. The segmental SNR as defined in Equation (5) represents an average energy ratio in a relevant frame, i.e. a segmental energy ratio of noise and a voice signal over the number of relevant frames. Herein, the noise signifies a difference between the original voice signal and the re-configured voice signal. When a signal is compressed, and a compressed signal is then decompressed at a receiving end, a difference between the original signal and a reconfigured signal is defined as noise. In this manner, as the value of a segmental SNR proposed in the present invention becomes larger, a better performance is obtained. Accordingly, if the value of the segmental SNR is larger than a reference value, the selection of a noise removal algorithm to be tested is definitely determined. Otherwise, the selection of a noise removal algorithm to be tested fails.

Meanwhile, the present invention provides a method for finding a noise removal algorithm necessary to obtain an optimal voice performance when a distance of a microphone array (i.e. a voice input device) from a speaking subject changes, as well as when a microphone array is a long distance away from a speaking subject. To this end, in the present invention, environments are classified into two cases. In the first case, a distance of a microphone array from a speaking subject is fixed, whereas in the second case, a distance of a microphone array from a speaking subject changes. In each of the two cases, the present invention provides a method for effectively finding a noise removal algorithm. Namely, the system and the method according to the present invention consider even an actual environment, as in the case of a mobile robot, where a distance from a speaking subject changes, so that an optimal voice performance can be obtained.

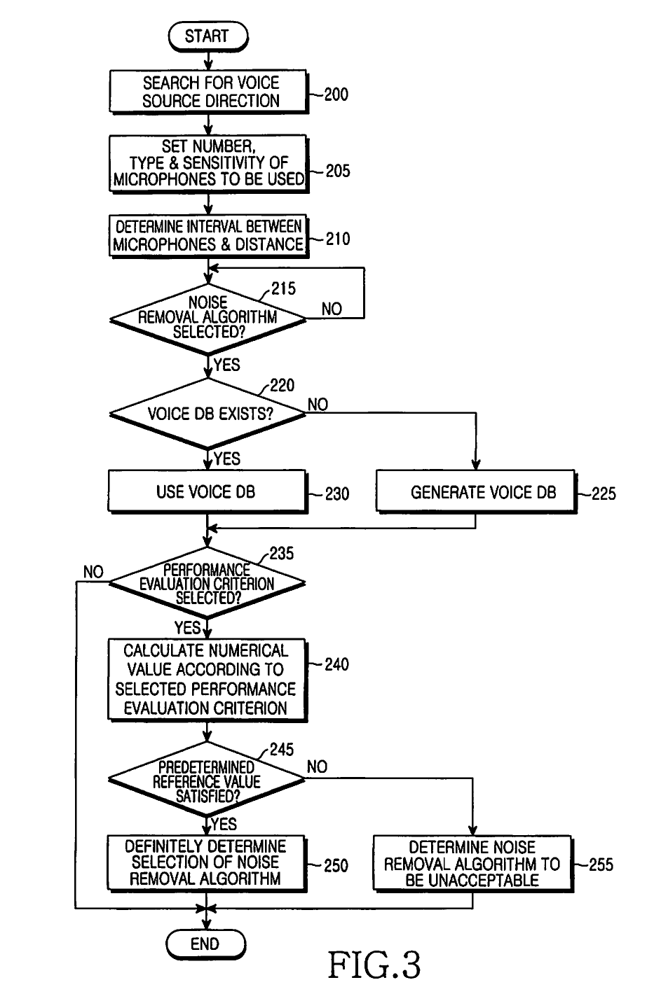

First, the selection of a noise removal algorithm will be described with reference to FIG. 3, which is a flowchart illustrating a control process for selecting the noise removal algorithm when a distance from a speaking subject is fixed according to one embodiment of the present invention.

In order to measure a voice performance when the distance from the speaking subject is fixed, a case may be assumed where a voice previously recorded in the voice database is reproduced through the speaker at a predetermined distance of the microphone array from the speaker.

Referring to FIG. 3, in step 200, the voice evaluation system searches for a voice source direction regarding a voice provided through the speaker corresponding to a speaking subject. Specifically, the voice evaluation system searches for the voice source direction based on a stereo camera and detection information, and the like. Then, the voice evaluation system adjusts the direction of the microphone array in such a manner as to face the found voice source direction. In step 205, the voice evaluation system sets a number, a type, and a sensitivity of microphones to be used in response to a predetermined distance for setting in hardware. Then, the voice evaluation system arranges the relevant microphones so as to face the found voice source direction. In step 210, the voice evaluation system determines an interval of the microphones and a location where a voice is output from the voice database, i.e. a distance between the speaking subject and the reference microphone. By doing this, the setting in the hardware of the microphone array is completed, wherein the setting is performed so that the voice reproduced when the microphone array is a predetermined distance away from the speaker during the reproduction of the voice stored in the voice database can be input through the microphone array. Namely, the construction of an environment necessary to find a noise removal algorithm is completed.

When the setting in the hardware is completed, a noise removal algorithm to be tested in a state based on the setting in the hardware should be selected. Accordingly, the voice evaluation system proceeds to step 215, and determines if the noise removal algorithm to be tested is selected. When it is determined in step 215 that the noise removal algorithm to be tested is selected, the voice evaluation system should determine if a desired level of a voice quality can be obtained when the selected noise removal algorithm is used. If a voice quality is poor when the selected noise removal algorithm is used, the currently selected noise removal algorithm to be tested is replaced by a next noise removal algorithm candidate to be tested, and accordingly, a voice quality is remeasured when the replaced noise removal algorithm to be tested is used. Also, in most experimental environments, a voice quality is measured in an anechoic environment for an accurate measurement thereof, but actually, the voice quality is measured in an echoic environment.

If the noise removal algorithm is selected as described above, the voice evaluation system proceeds to step 220, and determines if there exists a voice database in which previously recorded voices are stored. The voice database functions as equally providing used voices in order to ensure the same test conditions. If it is determined in step 220 that there exists no voice database, i.e. if there exist no previously stored voices, the voice evaluation system records voices in the voice collection environment as illustrated in FIG. 1, thereby generating a voice database in step 225. In other words, in the voice collection environment as illustrated in FIG. 1, a type of a noise source, a magnitude of a voice or noise, the degree of an angle, a distance from the speaking subject, the number of speaking subjects, etc., are determined, and voices are then recorded in a set environment. On the contrary, if it is determined in step 220 that there exists the voice database, the voice evaluation system reproduces and provides a stored voice by using the voice database in step 230.

When receiving as input the reproduced voice, the voice evaluation system determines in step 235 if performance evaluation criteria are selected. Herein, the performance evaluation criteria refer to formulas, each of which numerically expresses a voice quality in order to determine if a desired level of a voice quality is output when the noise removal algorithm to be tested is applied to an input voice. The present invention provides various formulas as the performance evaluation criteria as described above. Particularly, Equation (5) for calculating a segmental SNR of a voice signal from among them, is used as a basic performance evaluation criterion.

If it is determined that a performance evaluation criterion is not selected, the methodology terminates. Meanwhile, if it is determined that any one of the performance evaluation criteria is selected, the voice evaluation system proceeds to step 240, and performs an operation for calculating a numerical value equivalent to the selected performance evaluation criterion. At this time, the voice evaluation system applies the selected performance evaluation criterion to a voice to which the noise removal algorithm to be tested has been applied, thereby calculating a numerical value.

In step 245, the voice evaluation system determines if the numerical value as calculated in step 240 satisfies a predetermined reference value, i.e. if the numerical value is in a predetermined acceptable range. If it is determined in step 245 that the numerical value as calculated in step 240 satisfies the predetermined reference value, the voice evaluation system proceeds to step 250, and definitely determines the selection of the noise removal algorithm. On the contrary, if it is determined in step 245 that the numerical value doesn't satisfy the predetermined reference value, the voice evaluation system proceeds to step 255, and determines that the noise removal algorithm is unacceptable. Through the comparison of the numerical value calculated according to the performance evaluation criterion with the reference value, the calculated numerical value can be used to determine if a noise removal algorithm to be tested is acceptable or unacceptable.

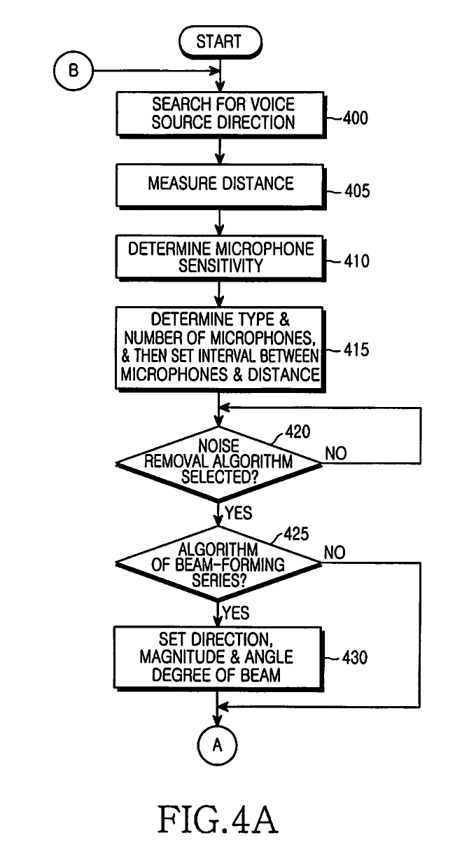

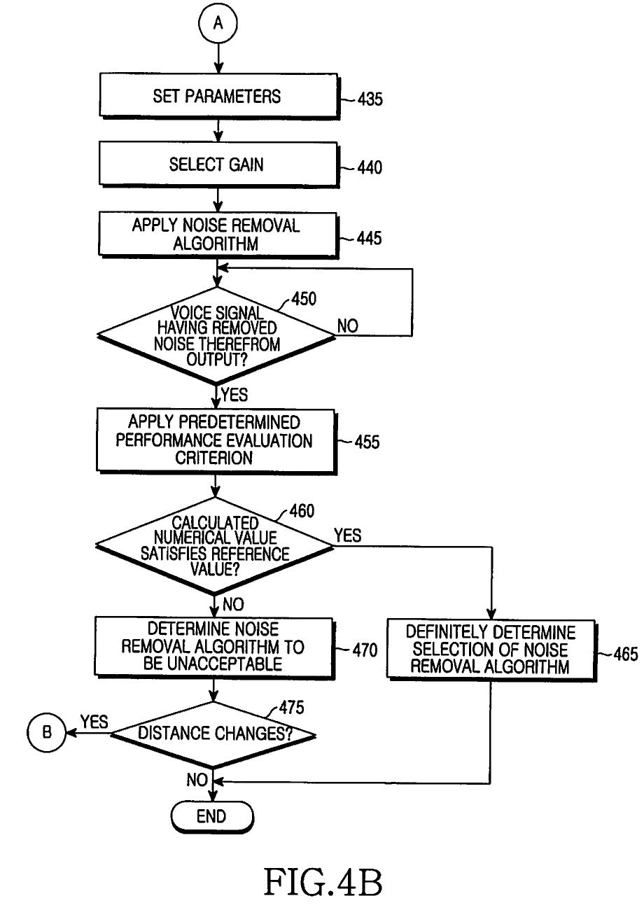

Hereinafter, the selection of a noise removal algorithm will be described with reference to FIGS. 4A and 4B, which are a flowchart illustrating a control process for selecting a noise removal algorithm when a distance from a speaking subject changes according to an embodiment of the present invention. In FIGS. 4A and 4B, a situation is assumed where the distance from the speaking subject changes in consideration of an actual mobile robot environment.

Referring to FIG. 4A, in step 400, the voice evaluation system searches for a voice source direction. Through the search of the voice source direction, the voice evaluation system arranges the microphone array so as to be in a state where the microphone array can receive as input an optimal voice. For example, when a beam-forming scheme, in which an object to be adjusted faces a particular direction, has a broadside form, the voice evaluation system moves the microphone array in order to configure the microphone array in a state parallel to the voice source. When a beam-forming scheme has an endfire form, the voice evaluation system moves the microphone array in order to configure the microphone array in a state perpendicular to the voice source. When a voice evaluation system has mobility as in the mobile robot, the voice evaluation system moves toward a voice source. On the other hand, in the case of other fixed voice evaluation systems, the voice evaluation system according to the present invention is equipped with the microphone array driving unit. Therefore, the scope of the present invention includes a case where the microphone array itself can move toward a voice source through the rotation thereof, as well as a case where the voice evaluation system moves toward the voice source. Also, in the case of an adaptive beam-forming scheme capable of adjusting a direction of a virtual beam by software, a virtual beam may be formed in a voice source direction without moving a microphone array.

After the microphone array is arranged so as to face the voice source direction in the hardware or software manner as described above, in step 405, the voice evaluation system measures a distance of the microphone array from the speaking subject. For example, a distance from a speaker (i.e. an electric speaker) from which the voice source is output may be a distance from the speaking subject. The distance as described above is measured using a sensing device, such as an ultrasonic sensor, a laser sensor, a stereo camera, etc., and auxiliary information may be acquired by using three-dimensional technology for tracking a voice source.

If the distance is obtained through the measurement, a sensitivity of a relevant microphone can be determined depending on the measured distance. Accordingly, in step 410, the voice evaluation system determines the sensitivity of the relevant microphone in response to the measured distance. Specifically, in the case of a long-distance speaking subject, a high-sensitive microphone is used in order to more sensitively receive a long-distance voice. At this time, as the long-distance voice is received with high sensitivity, relatively more noise flows into the high-sensitive microphone. On the contrary, in the case of a short-distance speaking subject, a low-sensitivity microphone through which a short-distance voice is well input whereas relatively less noise is received, is used. For example, in order to ensure a good voice performance in an actual environment, a microphone having a sensitivity of 36 to 38 dBs needs to be used when a distance is about 2 to 3 meters, and a microphone having a sensitivity of 42 to 44 dBs needs to be used when a distance is within 2 meters. Therefore, in the present invention, a look-up table on a microphone sensitivity equivalent to a distance from the speaking subject is made and can then be used. In the look-up table as described above, a microphone sensitivity equivalent to a distance is stored, e.g. 44 dBs to 1 meter, 42 dBs to 1.5 meters, 38 dBs to 2 meters, 36 dBs to 3 meters, and the like.

When a microphone sensitivity depending on each measured distance from the speaking subject is determined as described above, in step 415, the voice evaluation system determines a type and a number of microphones, and then sets an interval between the microphones and a distance of the microphone array from the speaking subject. First, the type and the number of the microphones is determined as follows. Microphones include an analog-type microphone, such as a condenser microphone, for acquiring a voice through the vibration of a diaphragm, a digital-type microphone where digital processing of an input voice is performed from an input stage, and the like. Commonly, many condenser microphones are used. Even though a group of condenser microphones has the same sensitivity among multiple condenser microphones, sensitivities of the group of condenser microphones are different from one another depending on the size of each condenser microphone. In a mobile communication terminal, the size of a used microphone is getting smaller from 8 phi, and recently, a microphone of a size below 4 phi is being used. However, actually, a condenser microphone of a size of 9.7 to 9.8 phi or above 12 phi has an even higher sensitivity. Therefore, the larger a size of the condenser microphone, the more appropriate the condenser microphone gets for a long distance.

Accordingly, a size of required microphones can be determined based on a measured distance. To this end, in the same manner as when a sensitivity of the microphones is determined, a look-up table on a size of a microphone equivalent to a distance (e.g. a first microphone of a size of 4 phi to 1 meter, a second microphone of a size of 6 phi to 2 meters, and the like) is made, and may then be used. Referring to the look-up table as described above, the size of the required microphones can be determined based on a distance of the microphone array from the speaking subject.

Herein, in the present invention, a user doesn't manually and directly change a sensitivity, a size, and a type of the microphones, but in a state where the voice evaluation system itself is equipped with the microphone array including multiple microphones for each type, relevant microphones, each of which is selected by the voice performance system, are used. When a type and a number of the microphones are determined as described above, a microphone array including the selected relevant microphones arranged at regular intervals is configured. To this end, an interval between the selected microphones should be determined.

Commonly, in a low frequency band, beam-forming is better formed (i.e. a beam width becomes smaller) as an interval of microphones becomes larger. On the other hand, in a high frequency band, aliasing occurs if an interval of microphones becomes equal to or larger than a predetermined interval. Therefore, for each frequency, an interval of the microphones should be changed. For example, theoretically, no aliasing occurs up to a frequency of 618 Hz when an interval of the microphones is equal to 5.5 cm, and no space aliasing occurs up to a frequency of 5666 Hz when an interval of the microphones is equal to 6 cm. However, the space aliasing occurs above a frequency of 5666 Hz. Accordingly, even though some aliasing exists in a low-voiced part, a better performance can be obtained in removing noise as a beam-width is reduced by a smaller amount in a low frequency part. Herein, when the interval of the microphones becomes equal to or larger than a predetermined interval, a better voice performance is obtained in a low-frequency band, whereas the voice performance is degraded in a high-frequency band. Based on the principle as described above, an interval between the microphones is determined in consideration of a trade-off between a desired beam width and space aliasing.

When the interval between the microphones is determined as described above, the microphone array driving unit moves the relevant microphones, so that they can be automatically arranged at regular intervals. In steps 400 to 415, the setting in hardware related to the relevant microphones is performed, in steps after step 420, setting in software is performed. In order to perform steps for the setting in the software, first, a noise removal algorithm should be selected. To this end, the voice evaluation system determines in step 420 if a noise removal algorithm to be tested is selected. When it is determined in step 420 that the noise removal algorithm to be tested is selected, the voice evaluation system determines in step 425 if the selected noise removal algorithm is an algorithm of a beam-forming series. If it is determined in step 425 that the selected noise removal algorithm is an algorithm of the beam-forming series, the voice evaluation system proceeds to step 430, and sets a direction, a magnitude, and an angle degree of a beam. Namely, in order to form a space filtering area for receiving as input a voice, a direction, a magnitude, and an angle degree of the beam are set. If it is determined in step 425 that the selected noise removal algorithm is not an algorithm of a beam-forming series, the methodology continues at step 435.

In step 435, the voice evaluation system sets parameters related to the noise removal algorithm. Types of parameters as described above and a method for setting the parameters are different from on another, depending on each noise removal algorithm to be tested. When the setting of the parameters is completed, the voice evaluation system proceeds to step 440 as illustrated in FIG. 4B, and selects a gain. Herein, in order to represent that step 430 as illustrated in FIG. 4A is connected to step 440 as illustrated in FIG. 4B, the symbol “A” is used. A gain necessary to select is usually applied to the selected noise removal algorithm, and it is necessary to determine an input/output gain of a voice signal representing a magnitude of the voice signal to be output and a board input/output gain regarding input/output signals of a hardware board, and the like. At this time, the gain should be determined in such a manner as to prevent a change of an SNR depending on each distance and the clopping that a voice signal is clipped due to a set gain. To this end, schemes, including an automatic gain control scheme, a look-up table scheme where a gain equivalent to a suitable distance is previously stored in the look-up table, can be used.

When the setting in the software as described above has been completed, in step 445, the voice evaluation system applies the selected noise removal algorithm to be tested to an input voice signal. Accordingly, the voice evaluation system determines in step 450 if a voice signal whose noise is removed is output. Namely, when the selected noise removal algorithm is applied to the input voice signal, a voice signal having the removed noise therefrom can be obtained. If it is determined in step 450 that the voice signal whose noise has been removed is output, in step 455, the voice evaluation system applies a predetermined performance evaluation criterion to the output voice signal. For example, the segmental SNR of the voice signal may be used as a basic performance evaluation criterion. By applying the performance evaluation criterion as described above, a numerical value necessary to evaluate if a desired voice performance is output is obtained.

When the numerical value is obtained as described above, the voice evaluation system determines in step 460 if the calculated numerical value satisfies a reference value. Namely, the voice evaluation system determines if the calculated numerical value is in a predetermined acceptable range. If it is determined in step 460 that the calculated numerical value is in the predetermined acceptable range (e.g. if a numerical value calculated according to the segmental SNR is larger than the reference value), the voice evaluation system proceeds to step 465, and definitely determines the selection of the noise removal algorithm. On the contrary, if it is determined in step 460 that the calculated numerical value doesn't satisfy the reference value (e.g. if the numerical value calculated according to the segmental SNR is smaller than the reference value), the voice evaluation system proceeds to step 470, and determines that the noise removal algorithm is unacceptable. Through the comparison of the numerical value calculated according to the performance evaluation criterion with the reference value, the calculated numerical value can be used to determine if a noise removal algorithm to be tested is acceptable or unacceptable. In step 475, the voice performance system determines if a distance changes. If it is determined in step 475 that a distance changes, the voice performance system returns to step 400 as illustrated in FIG. 4A, and performs setting in the hardware through the re-measurement of a distance. Then, the voice performance system selects another noise removal algorithm, and then goes through a process for verifying the selected noise removal algorithm.

As described above, through the performance evaluation criterion for evaluating a performance of a voice signal whose noise is removed, a recognition rate, an error reduction rate, a voice attenuation degree, a voice distortion degree, etc., of a voice, can be numerically expressed. The noise removal algorithm to be tested is verified through the comparison of the numerical value calculated according to the performance evaluation criterion with the reference value. By doing this, in a network robot including a mobile robot, the technique of removing noise in a surrounding environment for voice recognition or voice communication may be optionally used in consideration of a current environment.

As described above, by evaluating the performance of the voice having the removed noise therefrom, the system and the method according to the present invention may optionally use a multi-channel noise removal technique which is optimal for each situation. Also, through the performance evaluation of the voice having the removed noise therefrom, an optimal hardware configuration and an optimal combination between the optimal hardware configuration and software can be implemented for a long-distance voice-based service, such as voice recognition, a voice telephone call, and the like. As a result, even in a noise environment where a system including one or more used microphones operates, it is possible for a user to use a voice service in an optimal state where the voice service is provided by the system with even better voice quality and recognition performance.

While the invention has been shown and described with reference to certain preferred embodiments thereof, it will be understood by those skilled in the art that various changes in form and details may be made therein without departing from the spirit and scope of the invention as defined by the appended claims.

What is claimed is:

1. A system for evaluating a voice performance in order to recognize a long-distance voice, the system comprising:
a voice source direction search unit for finding a voice source direction in which a speaking subject is located so that a plurality of microphones face the voice source direction;
a distance measurement unit for measuring a distance from the speaking subject;
a voice input unit comprising the plurality of microphones, and for selecting at least one microphone necessary for a microphone array configuration in response to the measured distance;
a noise removal unit for applying a noise removal algorithm to be tested to a voice input through the voice input unit, and for removing noise from the input voice;
a performance evaluation verification unit for applying a performance evaluation criterion in order to numerically express a performance of the voice provided by the noise removal unit; and
a noise removal algorithm selection unit for determining if the noise removal algorithm is selected based on a result of comparing a numerical value calculated by the performance evaluation verification unit with a reference value.

2. The system as claimed in claim 1, wherein the voice input unit comprises a microphone array driving unit for arranging the plurality of microphones, for each of which a sensitivity and a type are considered in response to the measured distance, so as to face the voice source direction, and for moving each of the microphones in order to adjust each interval between the microphones.

3. The system as claimed in claim 1, wherein the distance measurement unit measures the distance from the speaking subject using at least one of an ultrasonic sensor, a laser sensor, and a stereo camera.

4. The system as claimed in claim 1, wherein the performance evaluation verification unit numerically expresses the performance of the voice provided by the noise removal unit using at least one of an error reduction rate, a Signal-to-Noise Ratio (SNR) increase rate, an Itakura-Saito distortion measure, a Cepstral distance, and a perceptual performance evaluation of a voice, regarding the voice input through the voice input unit.

5. The system as claimed in claim 2, wherein the voice source direction search unit moves a relevant microphone using the microphone array driving unit in order to configure a microphone array in a state parallel to the voice source direction when a fixed beam-forming scheme has a broadside form, and wherein the voice source direction search unit moves a relevant microphone using the microphone array driving unit in order to configure a microphone array in a state perpendicular to the voice source direction when a fixed beam-forming scheme has an endfire form.

6. The system as claimed in claim 2, wherein the voice source direction search unit forms a virtual beam in order to face the voice source direction when an adaptive beam-forming scheme is used.

7. The system as claimed in claim 1, wherein the performance evaluation verification unit numerically expresses a performance of a voice provided by the noise removal unit using a segmental Signal-to-Noise Ratio (SNR) of a voice signal.

8. The system as claimed in claim 7, wherein the segmental SNR of the voice signal is calculated using
$$Seg - S N R = \frac{10}{M} {\sum }_{m = 0}^{M - 1} log [ \frac{{\sum }_{n = Nm}^{N ( m + 1 ) - 1} {S}^{2} ( n )}{{\sum }_{n = Nm}^{N ( m + 1 ) - 1} {( S ( n ) - \hat{S} ( n ) )}^{2}} ] ,$$
wherein S(n) represents an original voice signal, Ŝ(n) represents a re-synthesized voice signal, and M and N represent a frame number and the length of a current frame, respectively.

9. The system as claimed in claim 8, wherein the noise removal algorithm selection unit definitely determines the selection of the noise removal algorithm when a numerical value calculated according to the segmental SNR of the voice signal is larger than the reference value.

10. A system for evaluating a voice performance in order to recognize a long-distance voice, the system comprising:
a voice source direction search unit for finding a voice source direction so that a plurality microphones face the voice source direction;
a voice database for storing therein voices recorded in a same collection environment necessary to evaluate a noise removal algorithm to be tested;
a voice input unit comprising the plurality of microphones for receiving as input a voice provided by the voice database, and for selecting at least one microphone necessary for a microphone array configuration;
a noise removal unit for applying the noise removal algorithm to be tested to a voice input through the voice input unit, and for removing noise from the voice;
a performance evaluation verification unit for applying a performance evaluation criterion in order to numerically express a performance of the voice provided by the noise removal unit; and
a noise removal algorithm selection unit for determining if the noise removal algorithm is selected based on a result of comparing a numerical value calculated by the performance evaluation verification unit with a reference value.

11. The system as claimed in claim 10, wherein the voice input unit comprises a microphone array driving unit for determining a number, a type, and a sensitivity of microphones to be used in response to a predetermined distance, arranging the microphones so as to face the voice source direction, and moving each of the microphones in order to adjust each interval between the microphones and a distance between a reference microphone and a location where a voice is output from the voice database.

12. The system as claimed in claim 10, wherein the performance evaluation verification unit numerically expresses a performance of a voice provided by the noise removal unit using a segmental Signal-to-Noise Ratio (SNR) of a voice signal.

13. The system as claimed in claim 12, wherein the segmental SNR of the voice signal is calculated using
$$Seg - S N R = \frac{10}{M} {\sum }_{m = 0}^{M - 1} log [ \frac{{\sum }_{n = Nm}^{N ( m + 1 ) - 1} {S}^{2} ( n )}{{\sum }_{n = Nm}^{N ( m + 1 ) - 1} {( S ( n ) - \hat{S} ( n ) )}^{2}} ] ,$$
wherein S(n) represents an original voice signal, Ŝ(n) represents a re-synthesized voice signal, and M and N represent a frame number and the length of a current frame, respectively.

14. The system as claimed in claim 13, wherein the noise removal algorithm selection unit definitely determines the selection of the noise removal algorithm when a numerical value calculated according to the segmental SNR of the voice signal is larger than the reference value.

15. A method for evaluating a voice performance in order to recognize a long-distance voice, the method comprising the steps of:
finding a voice source direction in which a speaking subject is located so that a plurality of microphones face the voice source direction;
measuring a distance from the speaking subject, and selecting at least one microphone necessary for a microphone array configuration in response to the measured distance;
applying a noise removal algorithm to be tested to a voice input through the at least one microphone and removing noise from the input voice;
applying a performance evaluation criterion for numerically expressing a performance of the voice whose noise has been removed;
comparing a numerical value calculated according to a result of applying the performance evaluation criterion with a reference value; and
determining if the noise removal algorithm is selected based on a result of comparing the numerical value with the reference value.

16. The method as claimed in claim 15, wherein, in the step of selecting at least one microphone, the plurality of microphones, for each of which a sensitivity and a type are considered in response to the measured distance, are arranged so as to face the voice source direction, and each interval between the microphones is then adjusted.

17. The method as claimed in claim 15, wherein, in the step of measuring a distance, at least one of an ultrasonic sensor, a laser sensor, and a stereo camera is used.

18. The method as claimed in claim 15, wherein the performance evaluation criterion corresponds to at least one of an error reduction rate, a Signal-to-Noise Ratio (SNR) increase rate, an Itakura-Saito distortion measure, a Cepstral distance, and a perceptual performance evaluation of a voice, regarding the voice input through the microphone.

19. The method as claimed in claim 15, wherein the performance evaluation criterion corresponds to a segmental Signal-to-Noise Ratio (SNR) of a voice signal, and the segmental SNR of the voice signal is calculated using
$$Seg - S N R = \frac{10}{M} {\sum }_{m = 0}^{M - 1} log [ \frac{{\sum }_{n = Nm}^{N ( m + 1 ) - 1} {S}^{2} ( n )}{{\sum }_{n = Nm}^{N ( m + 1 ) - 1} {( S ( n ) - \hat{S} ( n ) )}^{2}} ] ,$$
wherein S(n) represents an original voice signal, Ŝ(n) represents a re-synthesized voice signal, and M and N represent a frame number and the length of a current frame, respectively.

20. The method as claimed in claim 19, wherein, in the step of determining if the noise removal algorithm is selected, the selection of the noise removal algorithm is definitely determined when a numerical value calculated according to the segmental SNR of the voice signal is larger than the reference value.

21. A method for evaluating a voice performance in order to recognize a long-distance voice, the method comprising the steps of:
storing voices recorded in a same collection environment necessary to evaluate a noise removal algorithm to be tested;
finding a voice source direction so that a plurality of microphones face the voice source direction;
selecting at least one microphone for receiving as input a reproduced voice at a predetermined distance during reproduction of a stored voice;
applying the noise removal algorithm to be tested to the reproduced voice and removing noise from the reproduced voice;
applying a performance evaluation criterion for numerically expressing a performance of the reproduced voice whose noise has been removed; and
determining if the noise removal algorithm is selected based on a result of comparing a numerical value calculated by a result of applying the performance evaluation criterion with a reference value.

22. The method as claimed in claim 21, wherein the performance evaluation criterion corresponds to a segmental Signal-to-Noise Ratio (SNR) of a voice signal, and the segmental SNR of the voice signal is calculated using
$$Seg - S N R = \frac{10}{M} {\sum }_{m = 0}^{M - 1} log [ \frac{{\sum }_{n = Nm}^{N ( m + 1 ) - 1} {S}^{2} ( n )}{{\sum }_{n = Nm}^{N ( m + 1 ) - 1} {( S ( n ) - \hat{S} ( n ) )}^{2}} ] ,$$
wherein S(n) represents an original voice signal, Ŝ(n) represents a re-synthesized voice signal, and M and N represent a frame number and the length of a current frame, respectively.

23. The method as claimed in claim 22, wherein, in the step of determining if the noise removal algorithm is selected, the selection of the noise removal algorithm is definitely determined when a numerical value calculated according to the segmental SNR of the voice signal is larger than the reference value.
